(19) United States
(12) Patent Application Publication
(10) Pub. No.: US 2017/0348749 A1
(43) Pub. Date: Dec. 7, 2017

(54) SHARP ANGLE NOTCHING MARKS

(71) Applicant: Seoul Laser Dieboard System Co., Ltd., San Diego, CA (US)

(72) Inventor: Kyong Chan Lim, San Diego, CA (US)

(21) Appl. No.: 15/614,360

(22) Filed: Jun. 5, 2017

Related U.S. Application Data
(60) Provisional application No. 62/345,692, filed on Jun. 3, 2016.

(51) Int. Cl. B21D 7/02; B21D 7/03; B26D 3/14; B21F 1/00; B21D 7/022

(52) U.S. Cl. CPC B21D 7/021; B26D 3/14; B21F 1/00; B21D 7/03; B21D 7/022

(57) ABSTRACT

Making a plurality of notching marks on flanges of a rule to enable bending of the rule, including: punching the plurality of notching marks on the flanges of the rule to enable shaping of the rule into a channel letter; and tapering the flanges positioned around sharp notching angles made on the channel letter.

### CROSS-REFERENCE TO RELATED APPLICATIONS

This application claims the benefit of priority under 35 U.S.C. §119(e) of co-pending U.S. Provisional Patent Application No. 62/345,692, filed Jun. 3, 2016, entitled “Flat Notching.” The disclosure of the above-referenced application is incorporated herein by reference.

### BACKGROUND

### Technological Field

The present disclosure relates to notching marks made on flanges of a rule.

### Background

Notching marks are made on flanges of a rule to enable bending of the rule into a channel letter. However, additional preparations may be desirable to generate certain shapes or designs of the channel letter.

### SUMMARY

In general, this disclosure describes apparatus and methods related to making notching marks on the flanges of a rule to enable bending of the rule into a channel letter. As used herein, a “rule” may generally refer to a flat metallic strip. Additionally, a “profile” as used herein may generally refer to the rule having a rib as described below. In general, the rule or profile may be interchangeably used. In one embodiment, the flat notching marks are made on flanges of the rule to enable bending of the rule. Embodiments shown below also describe the flat notching marks made on flanges of the rule to enable bending of the rule into sharp angles.

In one embodiment, a method of making a plurality of notching marks on flanges of a rule to enable bending of the rule is disclosed. The method includes: punching the plurality of notching marks on the flanges of the rule to enable shaping of the rule into a channel letter; and tapering the flanges positioned around sharp notching angles made on the channel letter.

In another embodiment, an apparatus for making a plurality of notching marks on flanges of a rule to enable bending of the rule is disclosed. The apparatus includes: means for punching the plurality of notching marks on the flanges of the rule to enable shaping of the rule into a channel letter; and means for tapering the flanges positioned around sharp notching angles made on the channel letter.

In another embodiment, a device configured to make a plurality of notching marks on flanges of a rule to enable bending of the rule is disclosed. The device includes: a punching device configured to punch the plurality of notching marks on the flanges of the rule to enable shaping of the rule into a channel letter; and a tapering device configured to taper the flanges positioned around sharp notching angles made on the channel letter.

Other features and advantages of the present disclosure should be apparent from the following description which illustrates, by way of example, aspects of the disclosure.

### BRIEF DESCRIPTION OF THE DRAWINGS

The details of the present disclosure, both as to its structure and operation, may be gleaned in part by study of the accompanying drawings.

FIG. 1A shows the rule bent into a channel letter shape.

FIG. 1B shows the completed channel letter (e.g., letter “K”).

FIG. 2A shows a strip of rule.

FIG. 2B shows a flange formed on the rule.

FIG. 2C shows one side surface of a strip of profile.

FIG. 2D shows the other side surface of the strip of profile.

FIGS. 3A and 3B show the two ends of a rule connected at a point once the channel letter is formed.

FIG. 4 shows one example of a sharp notching angle.

FIG. 5A shows a notching device in accordance with one embodiment.

FIG. 5B a top perspective view of a sketch of the notching device in accordance with one embodiment.

FIG. 6A shows the notching marks made on the flange of the rule using the notching punches of the notching device illustrated in FIGS. 5A and 5B, for example.

FIG. 6B is a side perspective view of the rule with the notching marks and also showing the bending locations.

FIG. 6C shows the rule partially bent at a bending location.

FIG. 6D shows the rule completely bent into the sharp angle.

FIG. 7A shows the rule with the notching marks such that the flange pieces are tapered with tapered portions removed.

FIG. 7B shows the rule completely bent into the sharp angle.

FIG. 8 illustrates the difficulties of the rivet side with the bulged head not attaching flat to the surface, which can cause the channel letter to wobble when attached to a surface.

FIG. 9A shows a first step of a process for using the flat notching punch to remove the flange piece from the first end of the rule.

FIG. 9B shows the two ends of the rule with flange pieces.

FIG. 9C shows the two ends coupled together by sliding the two ends toward each other and the overlapping portion over the second end until the flange pieces meet without overlapping.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. In some instances, well-known structures and components are shown in simplified form for brevity of description. As used herein, like reference numerals refer to like features throughout the written description.

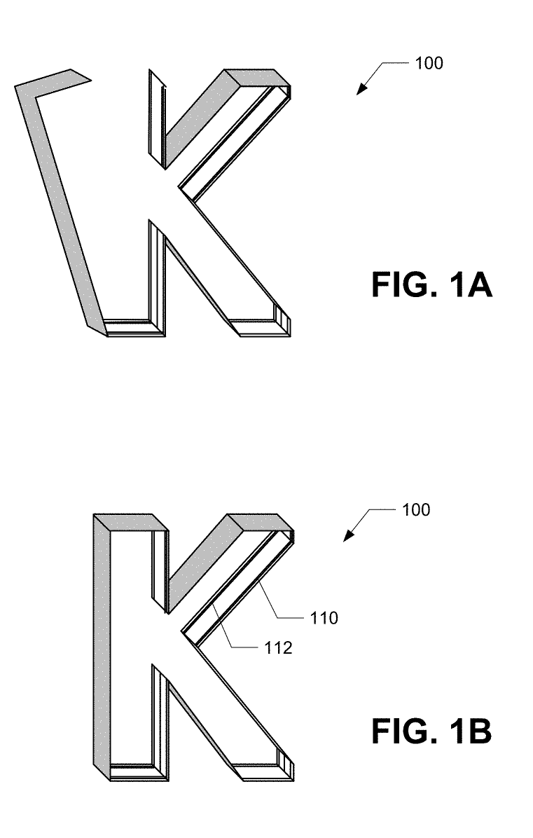

Rules (or profiles) may be used to form channel letters. For example, FIGS. 1A and 1B show a channel letter box 100 made with a profile in accordance with one embodiment of the present disclosure. FIG. 1A shows the rule bent into a channel letter shape. FIG. 1B shows the completed channel letter (e.g., letter “K”). As can be seen in FIG. 1B, for example, the channel letter box 100 includes a top rib 110 for retaining the top plate and a bottom rib 112 for fitting into a bottom plate. In one embodiment, the channel letter can be shaped into any shape, not just a letter of the alphabet or writing (e.g., Chinese letters). For example, the channel letter can be in a shape such as a heart shape.

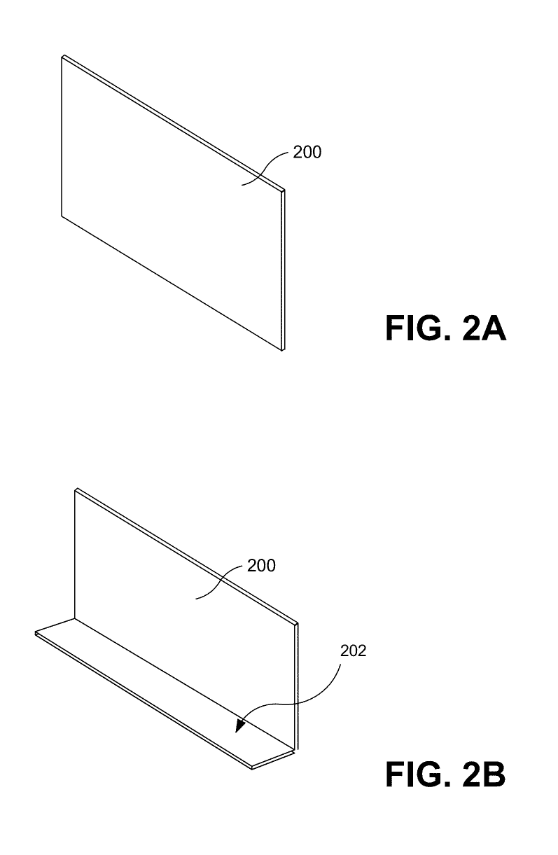

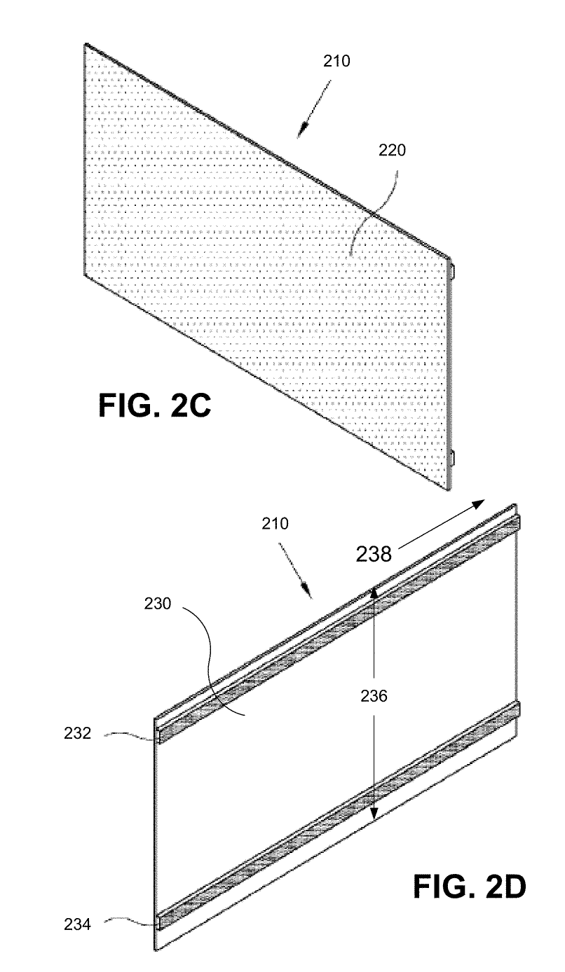

In one embodiment, the rules can be made into strips or rolls. FIG. 2A shows a strip of rule 200. FIG. 2B shows a flange 202 formed on the rule 200. FIG. 2C shows one side surface 220 of a strip of profile 210. FIG. 2D shows the other side surface 230 of the strip of profile 210. The other side surface 230 may include ribs 232, 234 to support the top and bottom covers of a channel letter. Thus, in one embodiment, a profile can be formed using a rule with at least one strip of rib attached to one surface of the rule.

In some embodiments, the profile 210 can have a first surface 230 shown in FIG. 2D. The first surface 230 may also be referred to herein as the “inside surface,” indicating that the first surface 230 may generally become the inside of a resulting channel letter once the profile 210 has been cut and folded. The profile 210 (or the rule 200) can generally have a profile height 236 on the order of a few centimeters (cm), for example, one or two cm to in excess of 20 cm. The profile height 236 can also describe the height of the first surface 230. The profile 210 may also be many meters long (in the direction of the profile axis 238). In some embodiments, the profile 210 (and the rule 200) can be stored in large rolls from which certain portions or lengths can be cut, for example, to produce the portion of the profile 210 shown. Lengths or sections of the profile 210, can be cut from the roll and then fed into a profile cutting and bending machine (not shown) to make a variety of channel letters or shapes from the profile 210.

In some embodiments, the rule 210 can be formed of a suitable metallic material, such as aluminum, steel, stainless steel, or various other alloys that provide a malleable, yet sturdy construction. The rule 210 may further have a protective coating to prevent corrosion or oxidation and to provide a suitable mounting surface for the ribs 232, 234. Such a protective coating can be applied at least to the first surface 230, but can also be applied to an outside surface 220. The outside surface 220 is opposite the first surface 230 and may generally become the outside of the resulting channel letter once the profile 210 is cut and folded.

In certain embodiments, such a protective coating may be an enamel coating. In some other embodiments, the profile 210 can be coated with certain types of powder coating, lacquer, or paint applied to the entire rule 200. In some embodiments, coating the rule 200 in enamel can have certain chemical advantages for adhering or bonding of the ribs 232, 234. The coating can further have desirable artistic or design characteristics provided by different colored coatings having various reflective or textured properties. For example, a white first surface 230 may have desirable reflective properties for light emitted from within a completed channel letter. The colors and coatings of the first surface 230 can be different from the colors and coatings of the outside surface.

As described above, the profile 210 can further have the ribs 232, 234. In some embodiments, the ribs 232, 234 can be attached, bonded, or otherwise adhered to the first surface 230 of the profile 210. In some embodiments, the ribs 232, 234 can be formed of a polymer, elastomer, plastic, fiber-reinforced plastic (FRP), or other suitable synthetic materials. In some other embodiments, the rib 232, 234 can be attached using a machine that applies or adheres the ribs 232, 234 in place on a blank surface 230 of the profile 210.

As noted above, the notching marks are made on the flanges of a rule to enable bending of the rule into a channel letter. However, additional preparations may be desirable to generate certain shapes or designs of the channel letter.

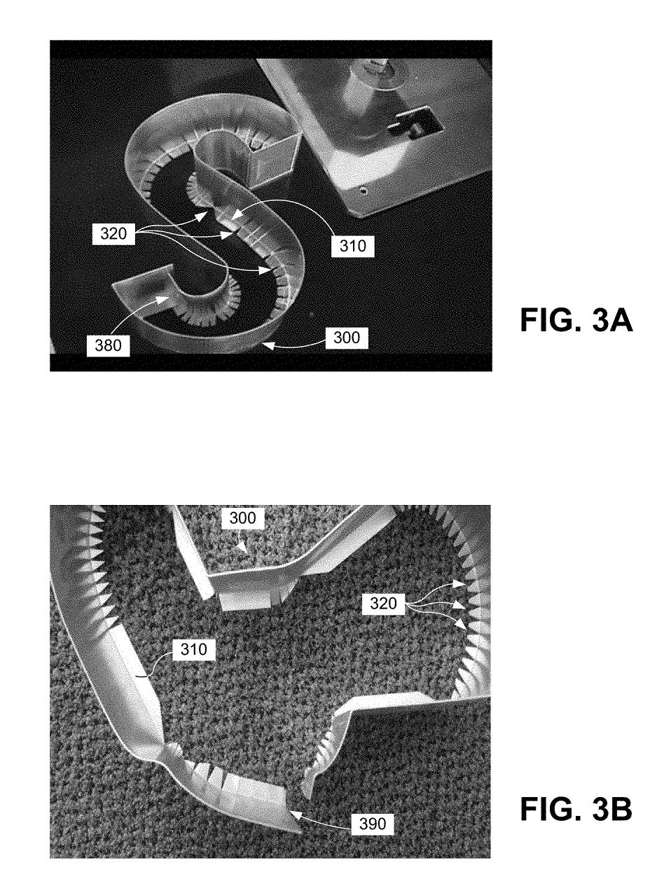

FIGS. 3A and 3B show notching marks 320 on the flanges 310 of the rule 300. Notching marks 320 are of different angles, which can range from 0 degree to 180 degrees. A notching angle of 0 degree would be no notching mark, while a notching angle near 180 degrees (e.g., between 140 and 180 degrees) would be a flat notching mark.

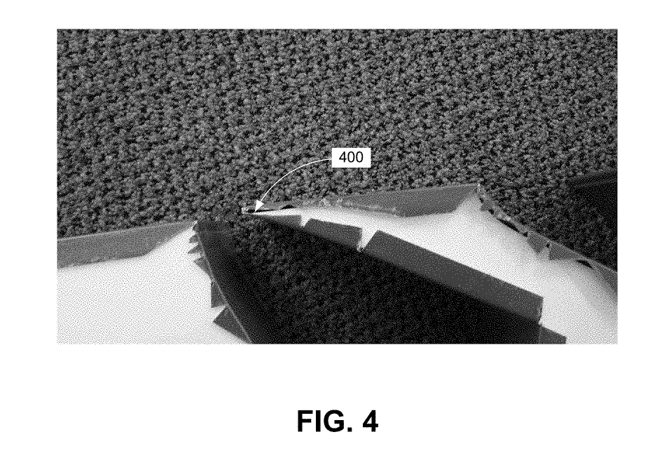

FIG. 4 shows one example of a sharp notching angle 400. As shown in FIG. 4, in areas near the sharp notching angle 400, the flanges interfere with each other, and the flanges must be filed and grounded to bend them into the sharp angle.

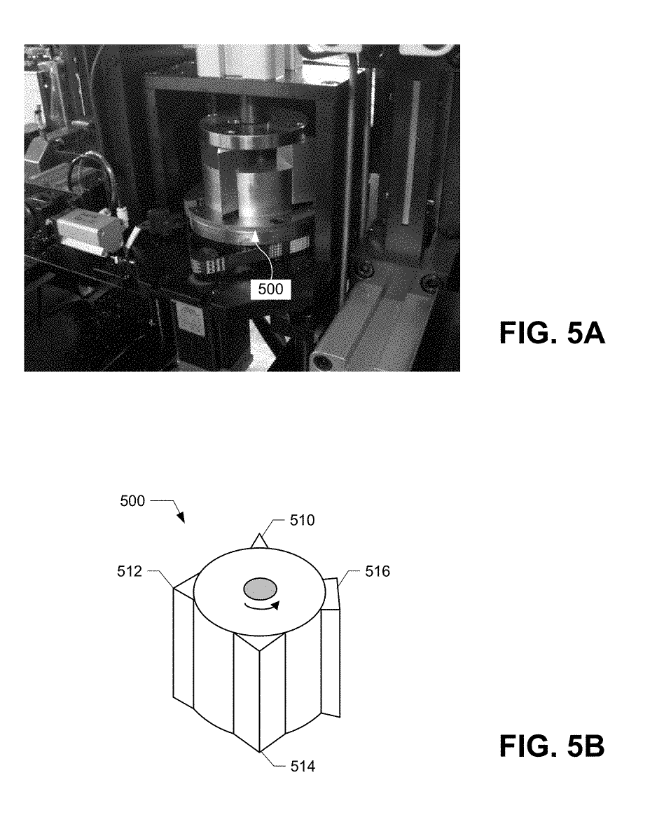

FIG. 5A shows a notching device 500 in accordance with one embodiment. Typically the notching device 500 is one of the units of a bending apparatus.

FIG. 5B is a top perspective view of the notching device 500 in accordance with one embodiment. The illustrated embodiment of FIG. 5B includes four notching punches 510, 512, 514, 516 of different angles (e.g., 30, 60, 120, and flat or 180 degrees). In one embodiment, the notching punch 510 makes a 30° notching mark. In another embodiment, the notching punch 512 makes a 60° notching mark. In another embodiment, the notching punch 514 makes a 120° notching mark. In yet another embodiment, the notching punch 516 makes a 180° or flat notching mark. In other embodiments, notching marks of different angles can be made.

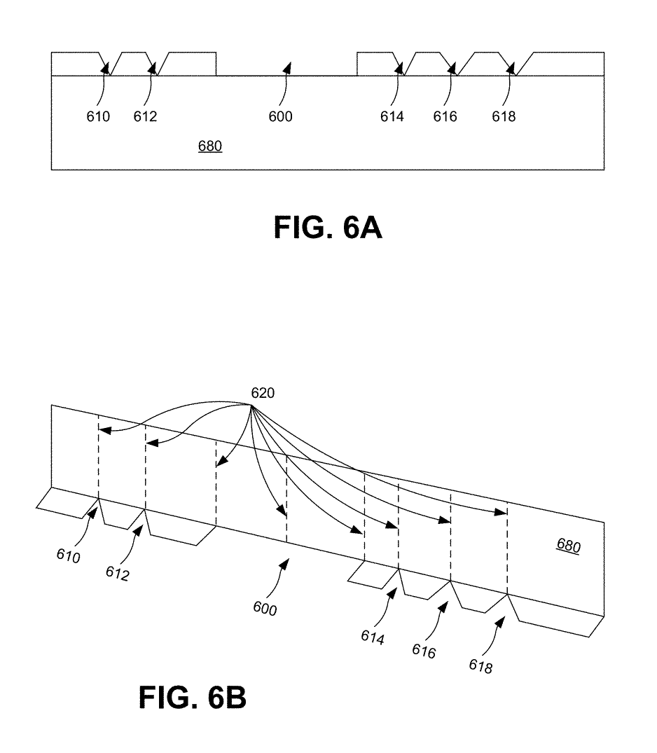

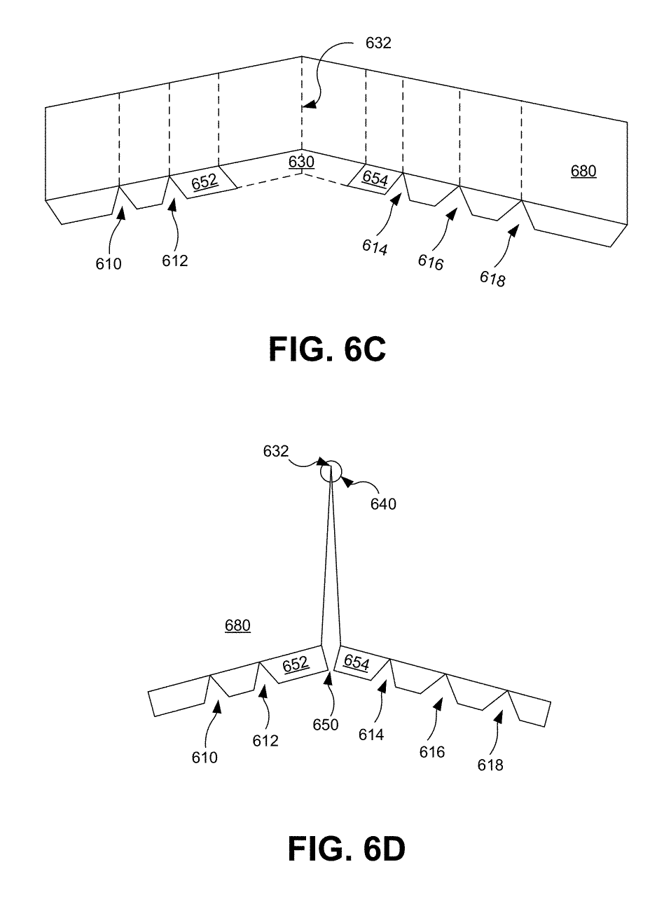

FIG. 6A shows the notching marks 600, 610, 612, 614, 616, 618 made on the flange of the rule 680 using, for example, the notching punches of the notching device 500 illustrated in FIGS. 5A and 5B.

In one example, the notching marks 610, 612, 614 are made with the 30° notching punch 510, while the notching marks 616, 618 are made with the 60° notching punch 512. Further, the notching mark 600 is made with the flat notching punch 516 to enable the rule 680 to be bent into a sharp angle.

FIG. 6B is a side perspective view of the rule 680 with the notching marks 600, 610, 612, 614, 616, 618 and also showing the bending locations 620.

FIG. 6C shows the rule 680 partially bent at bending location 632. The flange 630 is completely removed by the flat notching punch to make the sharp angle bend (as shown in FIG. 6D).

FIG. 6D shows the rule 680 bent into the sharp angle 640. It can be seen in the illustrated embodiment of FIG. 6D that when the rule 680 is bent at location 632 into the sharp angle 640, the adjacent flange pieces 652, 654 may contact or overlap at location 650. In one embodiment, the sharp notching angle 640 is an angle between 140 and 180 degrees.

To avoid the contact or interference, the flange pieces (e.g., the adjacent flange pieces 652, 654 in FIG. 6C or FIG. 6D) can be tapered.

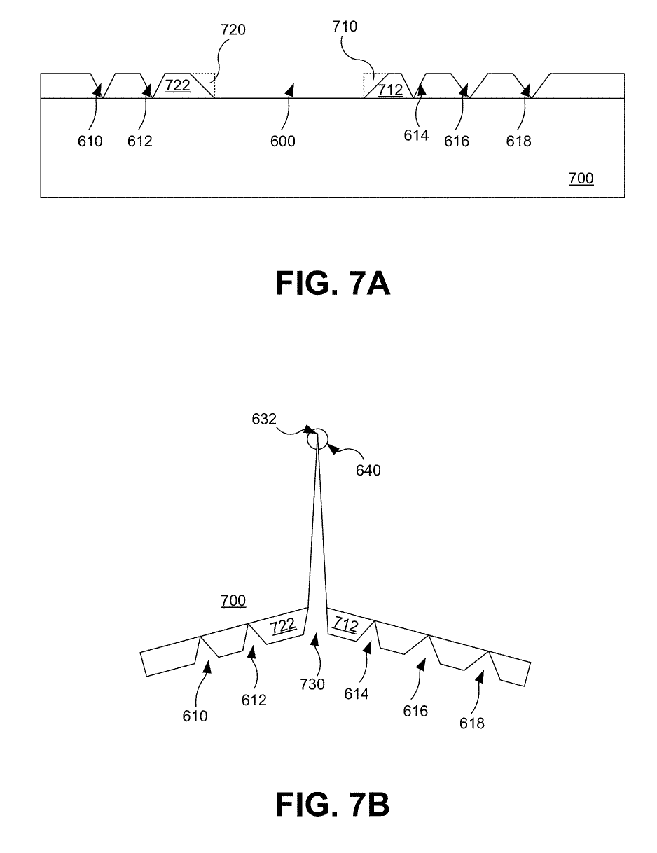

FIG. 7A shows the rule 700 with the notching marks 600, 610, 612, 614, 616, 618 such that the flange pieces 712, 722 are tapered with tapered portions 710, 720 removed. In one embodiment, the notching punches (e.g., punches 510, 512, 514, 516) of the notching device (e.g., notching device 500) are used to taper the flange pieces. In another embodiment, a cutting device is used to taper the flange pieces.

FIG. 7B shows the rule 700 bent into the sharp angle 640. It can be seen in the illustrated embodiment of FIG. 7B that when the rule 700 is bent into the sharp angle 640, the adjacent flange pieces 712, 722 do not contact, overlap, or interfere with each other.

In a further embodiment, the flat notching punch of the notching device is used for other purpose as well. For example, the flat notching punch can be used to punch out the flange of one end of the channel letter formed with the rule.

As shown in FIGS. 3A and 3B, once the channel letter is formed using the rule 300, the two ends need to be connected at point 380 (in FIG. 3A) or 390 (in FIG. 3B). Thus, to connect the two ends, the ends are overlapped and riveted. However, since the flange side is made to attach the channel letter to a surface, the bulged head of the rivet causes the channel letter to not attach properly (e.g., attach flat) to the surface.

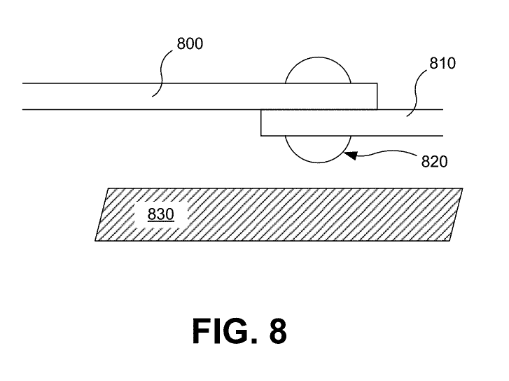

FIG. 8 illustrates the difficulties of the rivet side with the bulged head not attaching flat to the surface 830, which can cause the channel letter to wobble when attached to a surface 830. As shown in FIG. 8, the two ends 800, 810 of the rule (i.e., the flange of the rule) are overlapped and riveted with a rivet 820. However, the rivet 820 causes the channel letter to not attach properly to the surface 830 because the rivet 820 has a rounded and bulged head. Thus, in some embodiments, it is desirable to put the rivet which attaches the two ends on the rule side (e.g., side 200 of FIG. 2B) rather than on the flange side (e.g., side 202 of FIG. 2B).

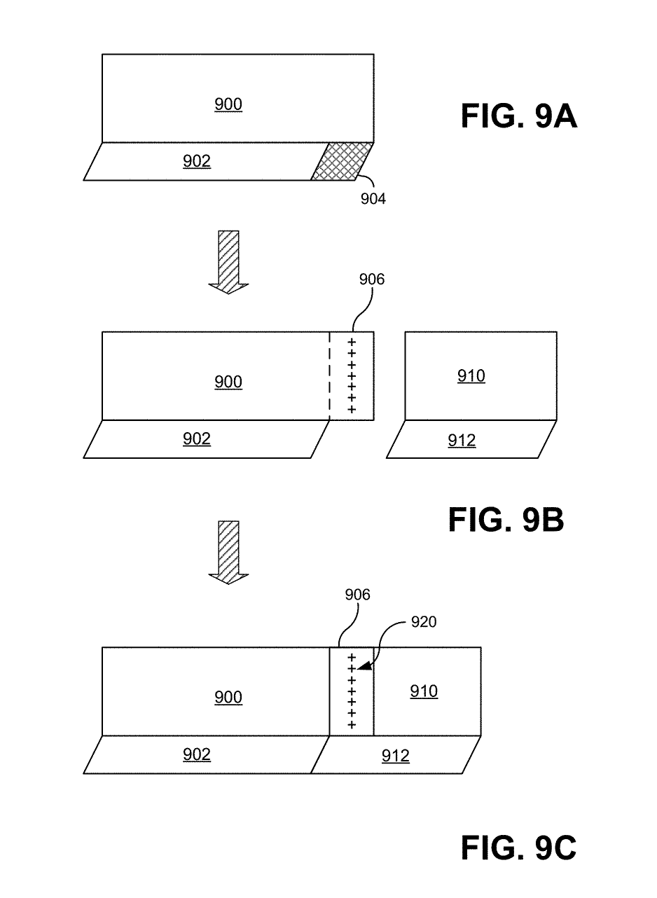

FIGS. 9A to 9C show the process for using the flat notching punch to remove the flange piece 904 from the first end 900 of the rule (see FIG. 9A). The remaining flange piece coupled to the first end 900 of the rule is labelled as 902.

FIG. 9B shows the two ends 900, 910 of the rule with flange pieces 902, 912. The flange piece 902 is coupled to the first end 900, while the flange piece 912 is coupled to the second end 910. The first end 900 also includes an overlapping portion 906 that will receive the rivets.

As shown in FIG. 9C, the two ends 900, 910 are coupled together by sliding the two ends 900, 910 toward each other and the overlapping portion 906 over the second end 910 until the flange pieces 902, 912 meet without overlapping. Finally, the two ends 900, 910 are attached together using the rivets 920. In other embodiments, the two ends 900, 910 can be attached using adhesives or other attachment means such as by soldering.

The above descriptions of the disclosed embodiments are provided to enable any person skilled in the art to make or use the disclosure. Various modifications to these embodiments will be readily apparent to those skilled in the art, and the generic principles described herein can be applied to other embodiments without departing from the spirit or scope of the disclosure. For example, although the examples shown in the illustrated figures include only one sharp angle made for a channel letter, multiple sharp angles can be made for the channel letter. Thus, it will be understood that the description and drawings presented herein represent embodiments of the disclosure and are therefore representative of the subject matter which is broadly contemplated by the present disclosure. It will be further understood that the scope of the present disclosure fully encompasses other embodiments that may become obvious to those skilled in the art and that the scope of the present disclosure is accordingly limited by nothing other than the appended claims.

Accordingly, the foregoing embodiments are merely presented as examples and are not to be construed as limiting the present disclosure. The present teachings can be readily applied to other types of apparatus and/or devices. The description of the present disclosure is intended to be illustrative, and not to limit the scope of the claims. Many alternatives, modifications, and variations will be apparent to those skilled in the art.

What is claimed is:

1. A method of making a plurality of notching marks on flanges of a rule to enable bending of the rule, the method comprising:
punching the plurality of notching marks on the flanges of the rule to enable shaping of the rule into a channel letter; and
tapering the flanges positioned around sharp notching angles made on the channel letter.

2. The method of claim 1, wherein the sharp notching angles include notching angles between 140 degrees and 180 degrees.

3. The method of claim 1, wherein the tapering includes
punching out portions of at least two of the flanges positioned around the sharp notching angles made on the channel letter so that the at least two of the flanges do not contact, overlap, or interfere with each other.

4. The method of claim 1, wherein the plurality of notching marks is made using a notching device including a plurality of notching punches.

5. The method of claim 4, wherein the punching includes
punching flat notching marks to enable the rule to be bent into the sharp notching angle.

6. The method of claim 1, further comprising
connecting ends of the rule to make the channel letter.

7. The method of claim 6, wherein the connecting ends of the rule comprises
punching a flat notching mark on a flange of one of the ends of the rule.

8. The method of claim 7, further comprising
connecting the flanges of the ends of the rule, while overlapping one end of the rule over the other end of the rule.

9. The method of claim 8, further comprising
riveting the overlapped ends of the rule.

10. An apparatus for making a plurality of notching marks on flanges of a rule to enable bending of the rule, the apparatus comprising:
means for punching the plurality of notching marks on the flanges of the rule to enable shaping of the rule into a channel letter; and
means for tapering the flanges positioned around sharp notching angles made on the channel letter.

11. The apparatus of claim 10, wherein the sharp notching angles include notching angles between 140 degrees and 180 degrees.

12. The apparatus of claim 10, wherein the means for tapering includes
means for punching out portions of at least two of the flanges positioned around the sharp notching angles made on the channel letter so that the at least two of the flanges do not contact, overlap, or interfere with each other.

13. The apparatus of claim 10, wherein the plurality of notching marks is made using a notching device including a plurality of notching punches.

14. The apparatus of claim 13, wherein the means for punching includes
means for punching flat notching marks to enable the rule to be bent into the sharp notching angle.

15. The apparatus of claim 10, further comprising
means for connecting ends of the rule to make the channel letter.

16. The apparatus of claim 15, wherein the connecting ends of the rule comprises
means for punching a flat notching mark on a flange of one of the ends of the rule.

17. The apparatus of claim 16, further comprising:
means for connecting the flanges of the ends of the rule; and
means for overlapping one end of the rule over the other end of the rule.

18. The apparatus of claim 17, further comprising
means for riveting the overlapped ends of the rule.

19. A device configured to make a plurality of notching marks on flanges of a rule to enable bending of the rule, the device comprising:
a punching device configured to punch the plurality of notching marks on the flanges of the rule to enable shaping of the rule into a channel letter; and
a tapering device configured to taper the flanges positioned around sharp notching angles made on the channel letter.
